(19) United States
(12) Patent Application Publication
(10) Pub. No.: US 2026/0320868 A1
(43) Pub. Date: Oct. 15, 2026

(54) GENERATING PANORAMIC VIDEOS

(71) Applicant: Google LLC, Mountain View, CA (US)

(72) Inventors: Erika LU, Mountain View, CA (US); Jingwei MA, Mountain View, CA (US); Brian CURLESS, Mountain View, CA (US); Tali DEKEL, Mountain View, CA (US); Shiran ZADA, Mountain View, CA (US); Aleksander HOLYNSKI, Mountain View, CA (US); Michael RUBINSTEIN, Mountain View, CA (US); Forrester COLE, Mountain View, CA (US)

(73) Assignee: Google LLC, Mountain View, CA (US)

(21) Appl. No.: 19/485,952

(22) PCT Filed: Dec. 27, 2024
(86) PCT No.: PCT/US2024/062142

§ 371 Date: Nov. 19, 2025

Related U.S. Application Data
(60) Provisional application No. 63/616,037, filed on Dec. 29, 2023.

(51) Int. Cl. G06T 11/60

(52) U.S. Cl. CPC G06T 11/60

(57) ABSTRACT

A media application receives an input panning video that includes image frames captured with a camera that pans at least once from a first side to a second side. The media application includes reprojecting the input panning video onto a panoramic canvas, wherein the panoramic canvas includes the image frames and missing regions. The media application further includes outputting, with a generative machine-learning model, a panoramic video that includes synthesized pixels for the missing regions of the panoramic canvas by: generating a base video at a coarse temporal scale that includes the synthesized pixels for the missing regions and refining the base video by performing temporal upsampling, merging the temporally upsampled base video with the panoramic canvas, and resynthesizing the synthesized pixels for the missing regions in the base video.

### CROSS-REFERENCE TO RELATED APPLICATIONS

This application is an International application that claims priority under 35 U.S.C. § 119(e) to U.S. Provisional Patent Application No. 63/616,037, filed on Dec. 29, 2023 and titled “Generating Panoramic Videos,” which is hereby incorporated by reference herein in its entirety.

### BACKGROUND

Panorama stitching refers to simulating a wider field-of-view image from a set of images captured by a camera rotating in place. For example, the set of images may be combined when a camera moves 180 degrees along the same axis. Panorama stitching includes sparse feature based or semi-dense registration; rigid or depth-compensated alignment; and image blending to resolve seams and inconsistencies across observations.

Panoramic videos are more complicated than panoramic images, especially where the panoramic video includes dynamic objects, since scene motion may cause failures in both registration and compositing. In addition, creating a panoramic video from images using conventional systems is not possible because as the camera captures images from a first location along an axis, other images are not captured from other locations along the axis, resulting in missing portions of a panoramic video.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented method includes receiving an input panning video that includes image frames captured with a camera that pans at least once from a first side to a second side. The method further includes reprojecting the input panning video onto a panoramic canvas, wherein the panoramic canvas includes the image frames and missing regions. The method further includes outputting, with a generative machine-learning model, a panoramic video that includes synthesized pixels for the missing regions of the panoramic canvas by: generating a base video at a coarse temporal scale that includes the synthesized pixels for the missing regions and refining the base video by performing temporal upsampling, merging the temporally upsampled base video with the panoramic canvas, and resynthesizing the synthesized pixels for the missing regions in the base video. In some embodiments, the computer-implemented method is implemented as a media application on a computing device.

In some embodiments, the temporal upsampling includes temporally upsampling the base video and performing spatial alignment and color alignment of the temporally upsampled base video with the panoramic canvas to obtain an aligned temporally upsampled vase video. In some embodiments the merging the temporally upsampled base video and the panoramic canvas includes merging the aligned temporally upsampled base video with the panoramic canvas. In some embodiments, the resynthesizing includes generating a mask of pixels for the missing regions, regenerating the synthesized pixels for the missing regions based on the mask, and merging the regenerated pixels with the synthesized pixels. In some embodiments, a quality of the panoramic video improves as a function of a number of times the image frames captured with the camera include panning from the first side to the second side and panning from the second side to the first side. In some embodiments, the input panning video includes one or more moving objects. In some embodiments, the method further includes responsive to outputting the panoramic video, applying a super-resolution pass to the panoramic video to increase resolution of the panoramic video. In some embodiments, the method further includes selecting a panoramic image from the panoramic video.

In some embodiments, a non-transitory computer-readable medium with instructions stored thereon that, when executed by one or more computers, cause the one or more computers to perform operations. The operations include receiving an input panning video that includes image frames captured with a camera that pans at least once from a first side to a second side; reprojecting the input panning video onto a panoramic canvas, wherein the panoramic canvas includes the image frames and missing regions; and outputting, with a generative machine-learning model, a panoramic video that includes synthesized pixels for the missing regions of the panoramic canvas by: generating a base video at a coarse temporal scale that includes the pixels for the missing regions and refining the base video by performing temporal upsampling, merging the temporally upsampled base video with the panoramic canvas, and resynthesizing the synthesized pixels for the missing regions in the base video.

In some embodiments, the temporal upsampling includes temporally upsampling the base video and performing spatial alignment and color alignment of the temporally upsampled base video with the panoramic canvas to obtain an aligned temporally upsampled vase video. In some embodiments, the merging the temporally upsampled base video and the panoramic canvas includes merging the aligned temporally upsampled base video with the panoramic canvas. In some embodiments, the resynthesizing includes generating a mask of pixels for the missing regions, regenerating the synthesized pixels for the missing regions based on the mask, and merging the regenerated pixels with the synthesized pixels. In some embodiments, the input panning video includes one or more moving objects. In some embodiments, the operations further comprise responsive to outputting the panoramic video, applying a super-resolution pass to the panoramic video to increase resolution of the panoramic video. In some embodiments, the operations further comprise selecting a panoramic image from the panoramic video.

In some embodiments, a system comprises one or more processors and a memory coupled to the one or more processors, with instructions stored thereon that, when executed by the processor, cause the processor to perform operations. The operations include receiving an input panning video that includes image frames captured with a camera that pans at least once from a first side to a second side; reprojecting the input panning video onto a panoramic canvas, wherein the panoramic canvas includes the image frames and missing regions; and outputting, with a generative machine-learning model, a panoramic video that includes synthesized pixels for the missing regions of the panoramic canvas by: generating a base video at a coarse temporal scale that includes the pixels for the missing regions and refining the base video by performing temporal upsampling, merging the temporally upsampled base video with the panoramic canvas, and resynthesizing the synthesized pixels for the missing regions in the base video.

In some embodiments, the temporal upsampling includes temporally upsampling the base video and performing spatial alignment and color alignment of the temporally upsampled base video with the panoramic canvas to obtain an aligned temporally upsampled vase video. In some embodiments, the merging the temporally upsampled base video and the panoramic canvas includes merging the aligned temporally upsampled base video with the panoramic canvas. In some embodiments, the resynthesizing includes generating a mask of pixels for the missing regions, regenerating the synthesized pixels for the missing regions based on the mask, and merging the regenerated pixels with the synthesized pixels. In some embodiments, the input panning video includes one or more moving objects. In some embodiments, the operations further comprise responsive to outputting the panoramic video, applying a super-resolution pass to the panoramic video to increase resolution of the panoramic video. In some embodiments, the operations further comprise selecting a panoramic image from the panoramic video.

### BRIEF DESCRIPTION OF THE DRAWINGS

FIG. 1 is a block diagram of an example network environment, according to some embodiments described herein.

FIG. 2 is a block diagram of an example computing device, according to some embodiments described herein.

FIG. 3 illustrates input images from an input panning video, input images projected onto a panoramic canvas, and output images from the resulting output panoramic video, according to some embodiments described herein.

FIG. 4 illustrates an example token-based model that outputs a panoramic video, according to some embodiments described herein.

FIG. 5 illustrates an example diffusion model that is trained to output a panoramic video, according to some embodiments described herein.

FIGS. 6A-D illustrate an example process for generating a panoramic video, according to some embodiments described herein.

FIG. 7 illustrates an example of how a diffusion model performs upsampling and outpainting to generate a panoramic video, according to some embodiments described herein.

FIG. 8 illustrates an example comparison of how probabilities during outpainting use a token-based model as compared to a diffusion model, according to some embodiments described herein.

FIG. 9 illustrates a flowchart of an example method to generate a panoramic video, according to some embodiments described herein.

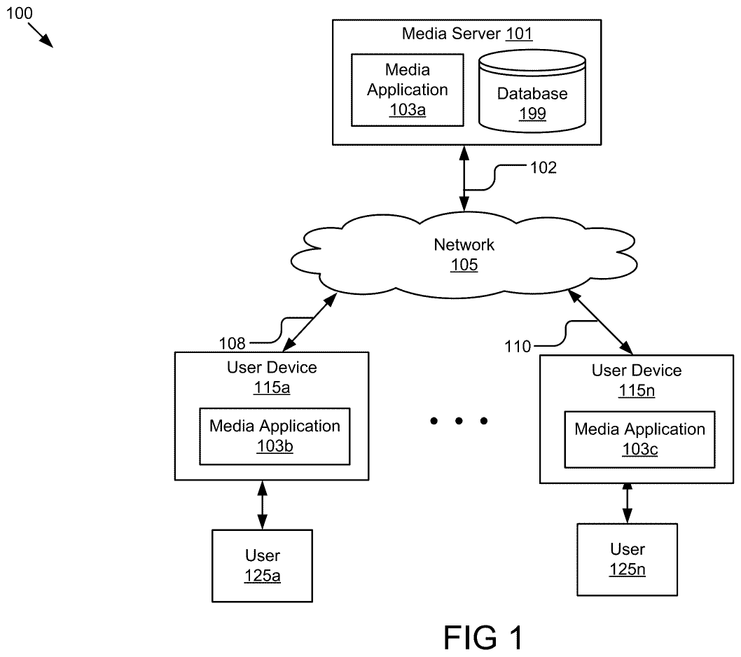

### DETAILED DESCRIPTION

### Overview

When a user captures an input video by panning a camera from side to side (or in any direction to capture different regions), the resulting panoramic video may have more synthesized pixels than original pixels. This exacerbates the need for image generation that properly tracks movement of objects in the panoramic video. For example, a panoramic video of people kayaking on a river not only needs image generation for still objects, such as buildings along the horizon, but also tracking and alignment of movement, such as the movement of paddles in the water. The task is also more difficult when the camera capturing the input video is moving during capture.

The technology described herein advantageously generates a panoramic video by reprojecting an input panning video onto a panoramic canvas, where the panoramic canvas includes the image frames from the input panning video and missing regions. A generative machine-learning model outputs a panoramic video that includes synthesized pixels for the missing regions of the panoramic canvas. For example, the generative machine-learning model may generate a base video at a coarse temporal scale that includes the synthesized pixels for the missing regions. In some embodiments, the generative model (and/or other techniques) may refine the base video by performing temporal upsampling, merging of the temporally upsampled base video with input pixels from the panoramic canvas, and resynthesizing of the synthesized pixels for the missing regions. The technology may be used with videos that include moving objects, moving people, portrait panoramic pans, etc.

### Example Computing Device

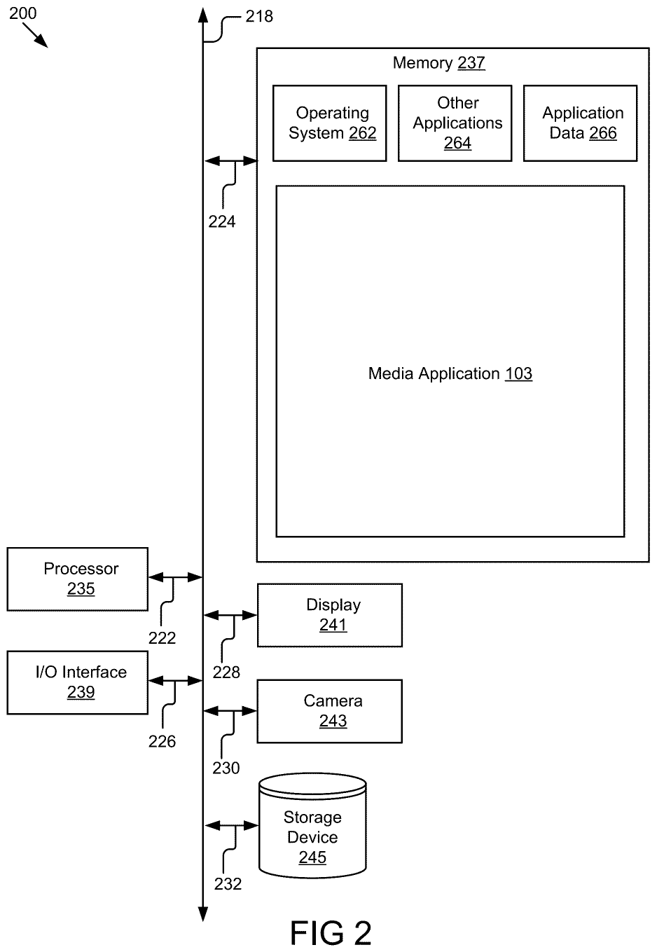

FIG. 2 is a block diagram of an example computing device 200 that may be used to implement one or more features described herein. Computing device 200 can be any suitable computer system, server, or other electronic or hardware device. In one example, the computing device 200 is the media server 101. In another example, the computing device 200 is a user device 115.

In some embodiments, computing device 200 includes a processor 235, a memory 237, an input/output (I/O) interface 239, a display 241, a camera 243, and a storage device 245, all coupled via a bus 218. The processor 235 may be coupled to the bus 218 via signal line 222, the memory 237 may be coupled to the bus 218 via signal line 224, the I/O interface 239 may be coupled to the bus 218 via signal line 226, the display 241 may be coupled to the bus 218 via signal line 228, the camera 243 may be coupled to the bus 218 via signal line 230, and the storage device 245 may be coupled to the bus 218 via signal line 232.

Processor 235 can be one or more processors and/or processing circuits to execute program code and control basic operations of the computing device 200. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems. In some embodiments, processor 235 may include one or more co-processors that implement neural-network processing. In some embodiments, processor 235 may be a processor that processes data to produce probabilistic output, e.g., the output produced by processor 235 may be imprecise or may be accurate within a range from an expected output. Processing need not be limited to a particular geographic location or have temporal limitations. For example, a processor may perform its functions in real-time, offline, in a batch mode, etc. Portions of processing may be performed at different times and at different locations, by different (or the same) processing systems. A computer may be any processor in communication with a memory.

Memory 237 is typically provided in computing device 200 for access by the processor 235, and may be any suitable processor-readable storage medium, such as random access memory (RAM), read-only memory (ROM), Electrical Erasable Read-only Memory (EEPROM), Flash memory, etc., suitable for storing instructions for execution by the processor or sets of processors, and located separate from processor 235 and/or integrated therewith. Memory 237 can store software operating on the computing device 200 by the processor 235, including a media application 103.

The memory 237 may include an operating system 262, other applications 264, and application data 266. Other applications 264 can include, e.g., an image library application, an image management application, an image gallery application, communication applications, web hosting engines or applications, media sharing applications, etc. One or more methods disclosed herein can operate in several environments and platforms, e.g., as a stand-alone computer program that can run on any type of computing device, as a web application having web pages, as a mobile application (“app”) run on a mobile computing device, etc.

The application data 266 may be data generated by the other applications 264 or hardware of the computing device 200. For example, the application data 266 may include images used by the image library application and user actions identified by the other applications 264 (e.g., a social networking application), etc.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 245), and input/output devices can communicate via I/O interface 239. In some embodiments, the I/O interface 239 can connect to interface devices such as input devices (keyboard, pointing device, touchscreen, microphone, scanner, sensors, etc.) and/or output devices (display devices, speaker devices, printers, monitors, etc.).

Some examples of interfaced devices that can connect to I/O interface 239 can include a display 241 that can be used to display content, e.g., images, video, and/or a user interface of an output application as described herein, and to receive touch (or gesture) input from a user. For example, display 241 may be utilized to display a user interface. Display 241 can include any suitable display device such as a liquid crystal display (LCD), light emitting diode (LED), or plasma display screen, cathode ray tube (CRT), television, monitor, touchscreen, three-dimensional display screen, or other visual display device. For example, display 241 can be a flat display screen provided on a mobile device, multiple display screens embedded in a glasses form factor or headset device, or a monitor screen for a computer device.

Camera 243 may be any type of image capture device that can capture images and/or video. In some embodiments, the camera 243 captures images or video that the I/O interface 239 transmits to the media application 103.

The storage device 245 stores data related to the media application 103. For example, the storage device 245 may store a training data set that includes training data, such as a plurality of training images, a generative machine-learning model, an outpainter model, etc.

The media application 103 receives an input panning video that includes image frames captured with the camera 243 that pans at least once from a first side to a second side. In some embodiments, the camera 243 captures multiple pans in one capture, such as a pan from the first side to the second side and then back to the first side again. For example, a user may take a user device 115 and move it from side-to-side multiple times to capture the input video. The resolution of the panoramic video is improved by multiple pans to improve tracking of movement in different spatial locations.

The resolution of a panoramic video is improved by the number of image frames that are captured at different angles because the increased number of image frames reduces the number of synthesized pixels that are generated for the missing regions in the panoramic video. In some embodiments, the input panning video includes one or more moving objects, such as moving people (e.g., a person kayaking on a river, a person scuba diving, people walking around a landmark, people skating), cars, trees, water, etc.

The media application 103 reprojects the input panning video onto a panoramic canvas to produce input frames (x⁰) and corresponding mask frames of valid pixels (m⁰) in a panorama coordinate system. The mask may be used to identify the valid pixels that are kept and the missing regions where synthesized pixels are to be generated. The panoramic canvas is a canvas with the dimensions of a panorama that includes the image frames and missing regions (of the scene that the camera didn't capture in the image frame captured at that instant). The panoramic canvas includes both the image frames from the input panning video that are positioned based on their coordinate location within the panoramic canvas and missing regions that may be illustrated with blank pixels, black pixels, or no data.

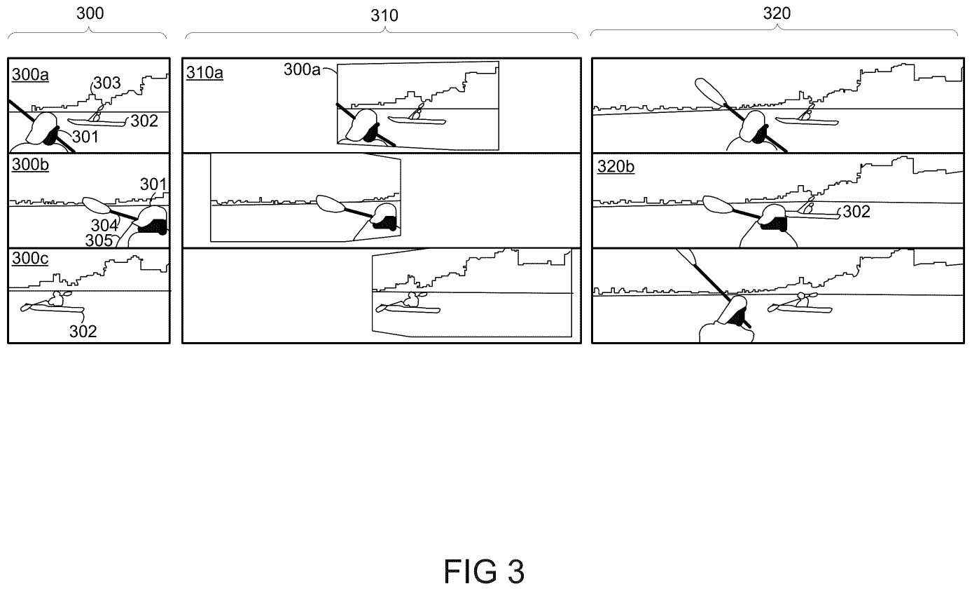

FIG. 3 illustrates three input images 300 from an input panning video, three input images 300 projected onto a panoramic canvas 310, and three output images 320 from an output panoramic video. The input images 300 depict people kayaking on a river. A first input image 300a includes a person 301 kayaking in the foreground, a person 302 kayaking in the background, and a skyline 303. A second input image 300b includes the first person 301 at a later time in the input panning video where the paddle 304 is at a different position compared to the first input image 300a and where a kayak 305 is also visible. A third input image 300c includes the second person 302 at a different position as compared to the first input image 300a.

The panoramic canvases 310 include respective input images 300 reprojected onto the panoramic canvases 310. In some embodiments, the media application 103 uses a homography solver to perform the reprojection of the input panning videos with rotation and no translation or scaling. In response to determining that parallax correction is needed, the media application 103 may use Simultaneous Localization And Mapping (SLAM) to perform the reprojection. In some embodiments, the media application 103 ignores the translation of the camera 243 and computes an elevation and azimuth of each input pixel's ray relative to a corresponding camera 243 direction and then projects each ray to an equirectangular canvas.

The output images 320 include synthesized pixels for the missing regions of the panoramic canvases 310. For example, the second output image 320b includes the second person 302, which was not visible in the second input image 300b.

To ensure consistent motion across time, the media application 103 temporally downsamples the input panning video to a context window length used by a generative machine-learning model that is part of the media application 103. In some embodiments, the media application 103 prepares the temporally-downsampled version of the input frames of the input panning video

$$( {\{ {x}^{k} \}}_{k = 1}^{K} )$$

such that the coarsest input (x^{K}) fits exactly or approximately in a context window used by the generative machine-learning model (e.g., 80 frames, 11 frames, etc.). In some embodiments, the media application 103 applies temporal prefiltering with a box blur before subsampling from x⁰ to avoid temporal aliasing.

In some embodiments, the input panning video is wider than the generative machine-learning model's native aspect ratio. The media application 103 may downscale the input panning video (x^{K}) to match the generative machine-learning model's native height.

### Generative Machine-Learning Model

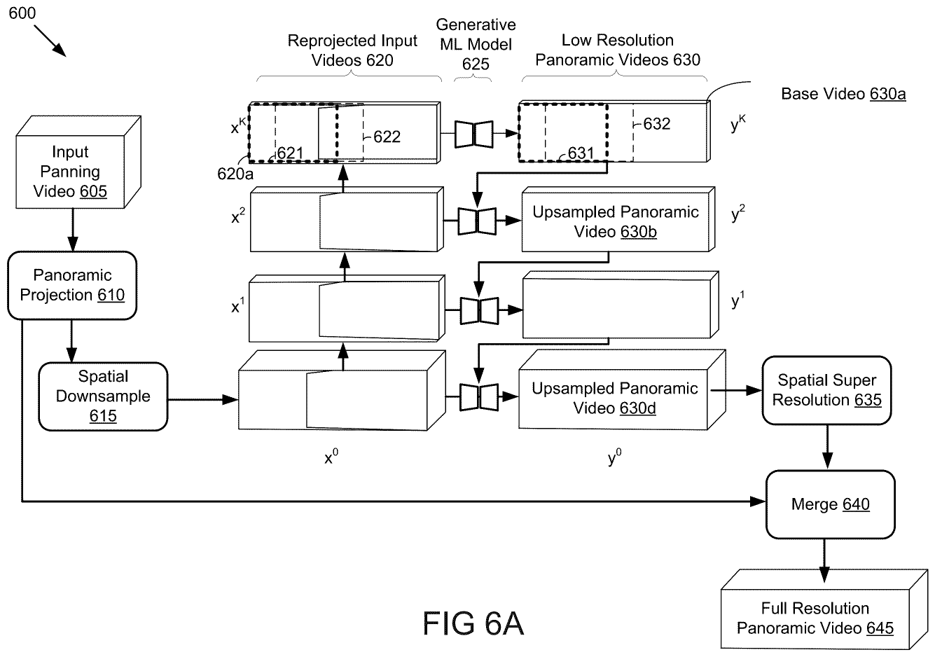

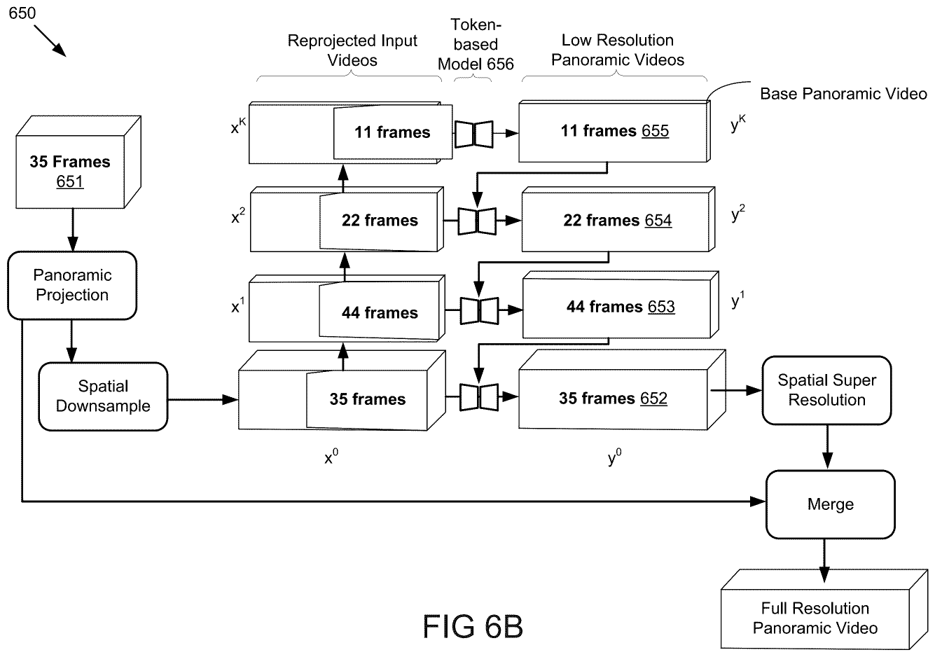

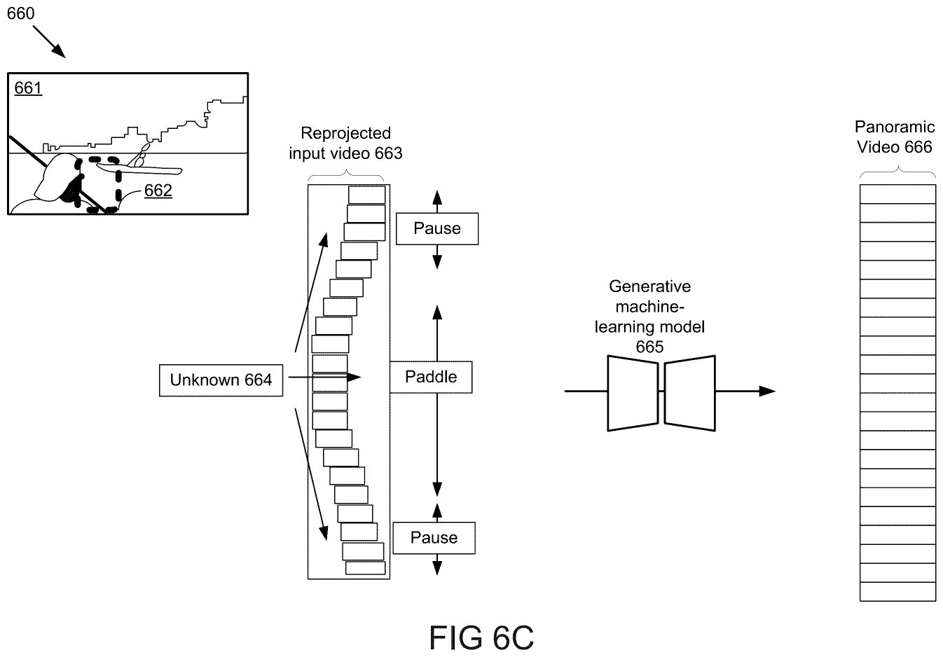

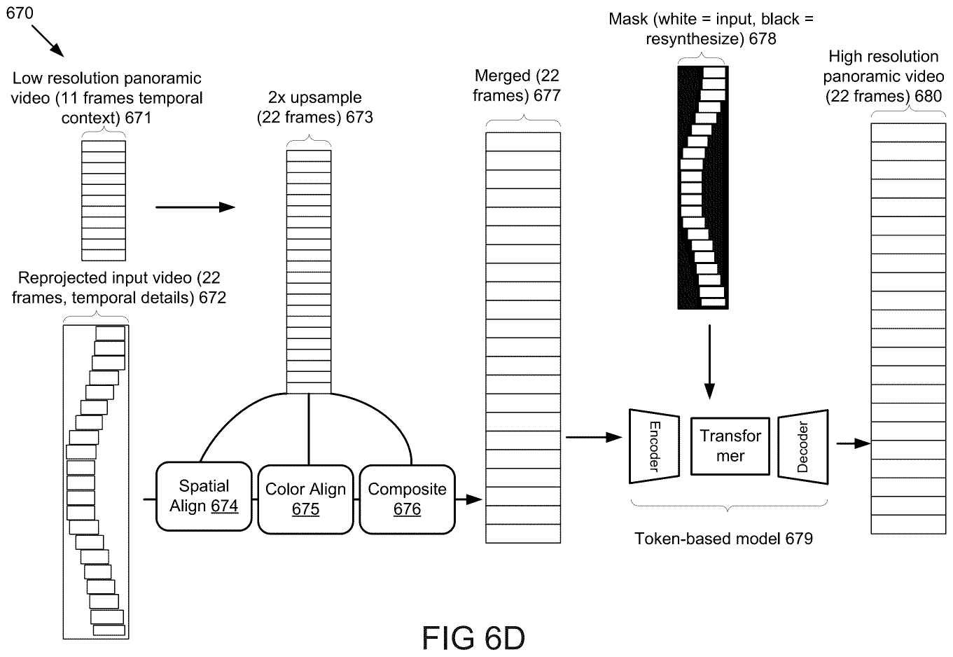

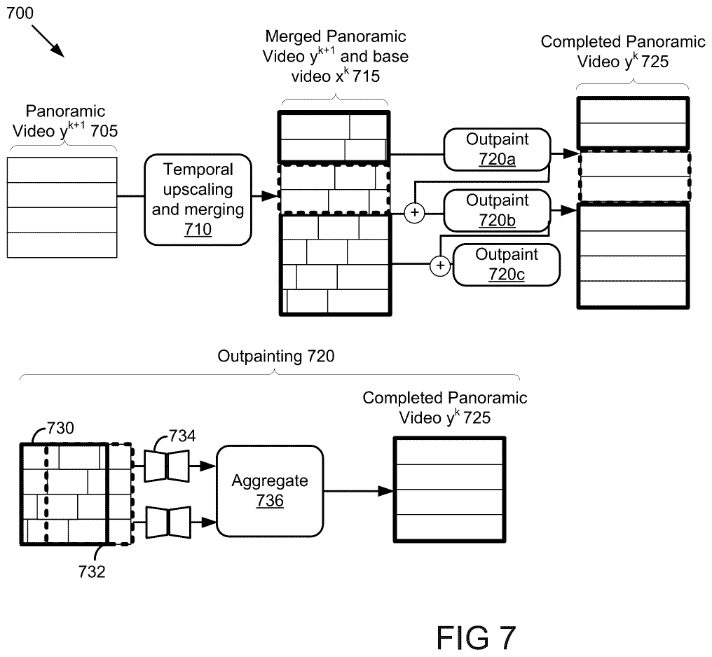

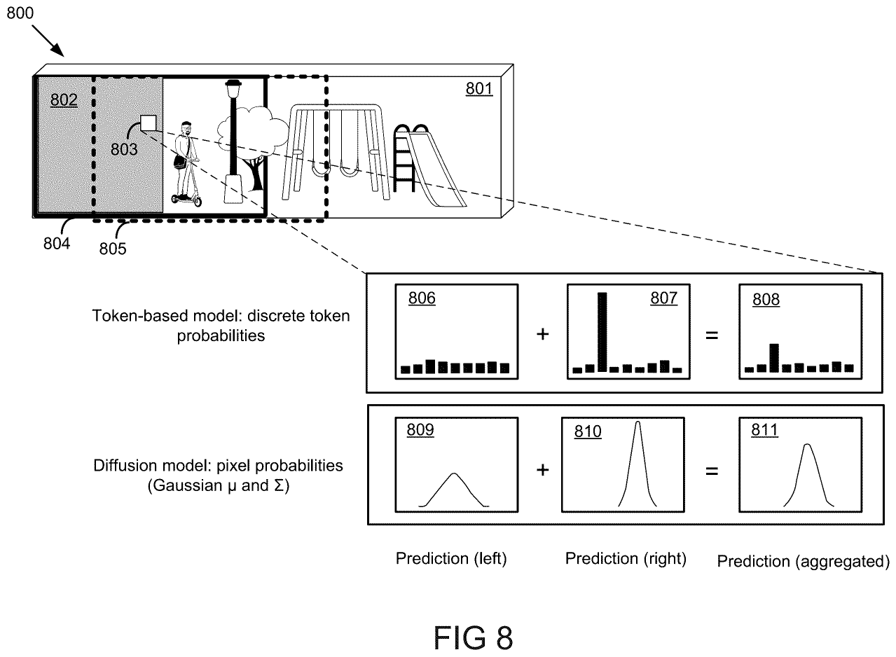

The generative machine-learning model generates a base video at a coarse temporal scale that includes synthesized pixels for the missing regions. In some embodiments, the generative machine-learning model outputs multiple overlapping spatial windows to span the panorama width. This process is discussed in greater detail below with reference to FIGS. 6A-D, FIG. 7, and FIG. 8. The generative machine-learning model may average the distributions predicted by the generative machine-learning model in each window and output base image frames for the base video based on the average.

The generative machine-learning model refines the base video using temporal upsampling, merging of the base video with the input pixels from the input panning video, and resynthesizing the synthesized pixels for the missing regions.

The media application 103 uses training data to train the generative machine-learning model to output a panoramic video from input data, such as application data 266 (e.g., an input panning video captured by the user device 115). Training data may be obtained from any source, e.g., a data repository specifically marked for training, data for which permission is provided for use as training data for machine learning, etc. In some embodiments, the training may occur on the media server 101 that provides the training data directly to the user device 115, the training occurs locally on the user device 115, or a combination of both.

The trained machine-learning model may include one or more model forms or structures. For example, model forms or structures can include any type of neural-network, such as a linear network, a deep-learning neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that receives as input sequential data, such as words in a sentence, frames in a video, etc. and produces as output a result sequence), etc.

The model form or structure may specify connectivity between various nodes and organization of nodes into layers. For example, nodes of a first layer (e.g., an input layer) may receive data as input data or application data 266. Such data can include, for example, one or more pixels per node, e.g., when the trained model is used for analysis, e.g., of an image. Subsequent intermediate layers may receive as input, output of nodes of a previous layer per the connectivity specified in the model form or structure. These layers may also be referred to as hidden layers. A final layer (e.g., output layer) produces an output of the generative machine-learning model. In some implementations, model form or structure also specifies a number and/or type of nodes in each layer.

In different implementations, the trained generative machine-learning model can include one or more models. One or more of the models may include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output. In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a graphics processing unit (GPU), or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM).

In some implementations, the trained model may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using training data, to produce a result.

Training may include applying supervised learning techniques. In supervised learning, the training data can include a plurality of inputs (e.g., a plurality of input panning videos) and a corresponding groundtruth output for each input (e.g., a groundtruth panoramic video for each input panning video). Based on a comparison of the output of the model (e.g., a panoramic video) with the groundtruth output (e.g., the groundtruth panoramic video), values of the weights are automatically adjusted, e.g., in a manner that increases a probability that the model produces the groundtruth panoramic video.

In various implementations, a trained model includes a set of weights, or embeddings, corresponding to the model structure. In some implementations, the trained generative machine-learning model may include an initial set of weights, e.g. downloaded from a server that provides the weights. In various implementations, a trained generative machine-learning model includes a set of weights, or embeddings, corresponding to the model structure. In implementations where data is omitted, the media application 103 may generate a trained generative machine-learning model that is based on prior training, e.g., by a developer of the media application 103, by a third-party, etc.

In some embodiments, where the generative machine-learning model includes a convolutional neural network trained using supervised learning, the training of the generative machine-learning model may include, for each input panning video, obtaining a panoramic video based on the input panning video. The generative machine-learning model may calculate a loss value based on a comparison of the panoramic video and the groundtruth panoramic video (included in the training data). For example, the generative machine-learning model may compute an optical flow EndPoint Error (EPE) to measure the consistency of the generated motion. The flow between consecutive frames of the groundtruth and the output video may be calculated as an L2 difference. In some embodiments, small motions at low image resolution may be evaluated based on a grid-based flow to produce more reliable sub-pixel alignments than a network-based flow. In some embodiments, pixel-level metrics may be evaluated separately for static and dynamic regions.

The generative machine-learning model may update a weight of one or more nodes of the convolutional neural network based on the loss value (e.g., in a way that, after adjustment and running another cycle of the training, the loss value is reduced, till the loss value is below a threshold).

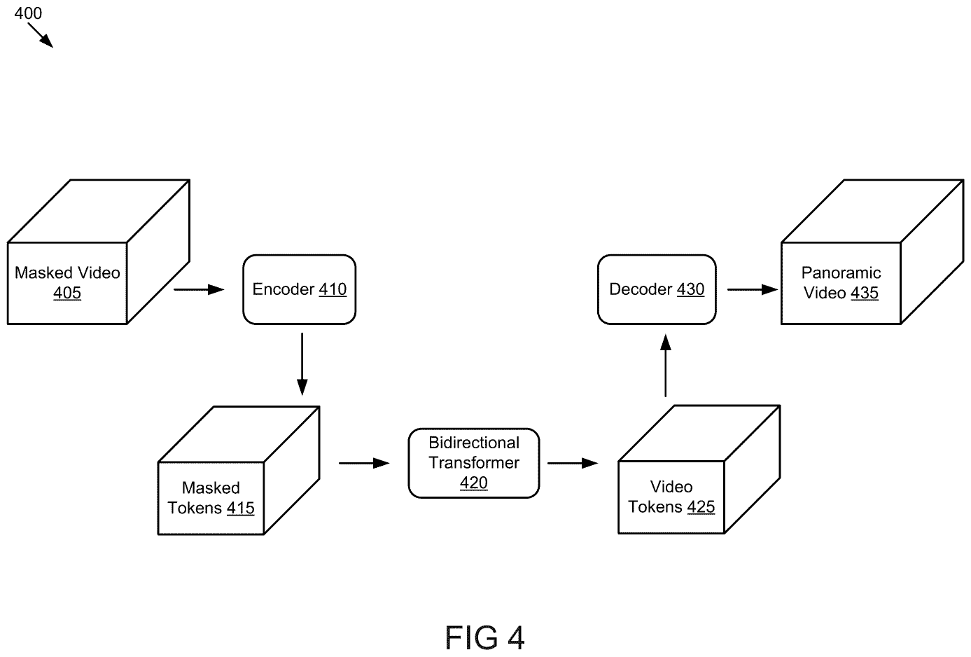

In some embodiments, the generative machine-learning model is a token-based model. FIG. 4 illustrates an example token-based model 400 that outputs a panoramic video, according to some embodiments described herein. The token-based model 400 includes an encoder 410, a bidirectional transformer 420, and a decoder 430. The encoder 410 receives a masked video 405 (e.g., the reprojected input panning video) that is downsampled (e.g., to 11 frames per second at 160×96 pixels) and compresses the masked video 405 into masked tokens 415. In some embodiments, the mask includes input pixels where synthesized pixels are generated for the regions outside of the mask. The masked tokens 415 represent discrete embeddings that describe the content of the masked video 405. In some embodiments, the attention layers of the encoder 410 are masked such that later frames attend to earlier frames in the window, but earlier frames are blocked from attending to later frames.

The bidirectional transformer 420 iteratively translates the masked tokens 415 into video tokens 425. The bidirectional transformer 420 that performs forward passes and backward passes over the coarsest level clip (x^{K}) to reduce or eliminate artifacts in the panoramic video. The bidirectional transformer 420 may take a result of a forward pass in regions that were previously seen by the bidirectional transformer 420 and combine the result with a backward pass in the rest of the regions to obtain the video tokens 425. The video tokens 425 are decoded by the decoder 430 to output a panoramic video 435 that is similarly downsampled (e.g., 11 frames per second at 160×96 pixels). The panoramic video 435 is upsampled (e.g., 320×192 pixels).

In some embodiments, the generative machine-learning model is a diffusion model, such as a space-time, pixel diffusion model. The diffusion model is trained to generate panoramic videos by progressively adding noise to panoramic videos (noising) and then training the diffusion model to perform a denoising process to recover the original panoramic videos from the noise. The media application 103 trains a diffusion model to receive a reprojected input panning video as input and output a panoramic video that includes synthesized pixels for the missing regions of the panoramic canvas.

In some embodiments, the media application 103 trains the diffusion model on an image outpainting task where the training data includes image pairs of a ground truth image and a corresponding image with random pixels or groups of pixels that are removed. As a result of training the diffusion model on outpainting tasks, the diffusion model is trained to receive an incomplete input image and output an image with synthesized pixels that replace any missing regions.

In some embodiments, the diffusion model is fine-tuned by using training videos where a fixed mask is replaced with a panning mask to simulate the situation where a user captures an input panning video by moving a camera from side to side. In some embodiments, the media application 103 performs fine-tuning of the trained diffusion model using video pairs of natural videos (ground truth videos) paired by masked videos with synthetic panoramic masks that are designed to mimic real masks.

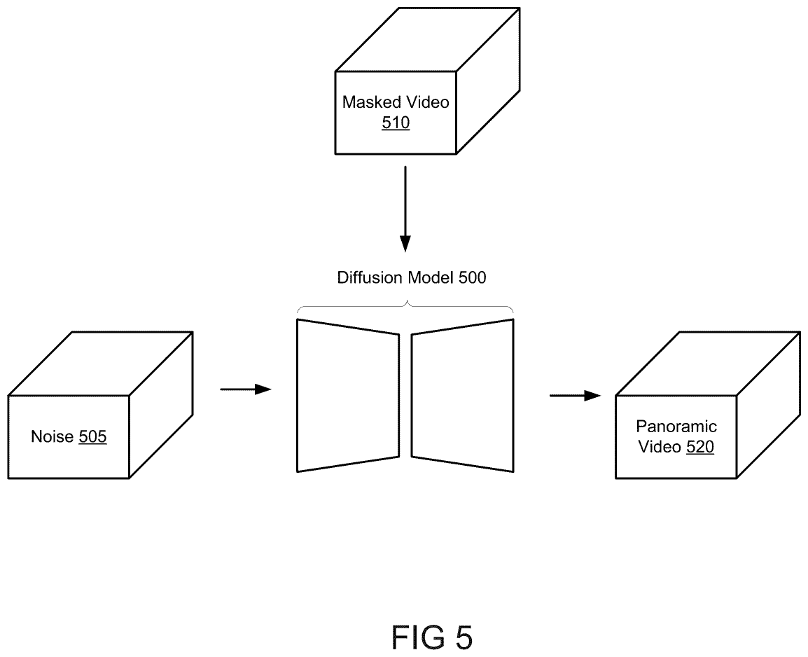

FIG. 5 illustrates an example diffusion model 500 that is trained to output a panoramic video, according to some embodiments described herein. The diffusion model 500 receives noise 505 and a masked video 510. In some embodiments, the diffusion model 500 receives noise 505 and a masked video 510 that are downsampled (e.g., 80 frames that are 128×128 pixels) and outputs a panoramic video 520 that is similarly downsampled. The panoramic video 520 may be a base layer that is upsampled to 1024×1024 pixels.

FIGS. 6A-D illustrate an example process for generating a panoramic video. Although the examples mention particular numbers of frames, the numbers of frames are used as examples and other numbers of frames may also be used. FIG. 6A includes a process 600 with an input panning video 605. A panoramic projection 610 projects the input panning video 605 on a panoramic canvas (starting with the temporally finest input frames x⁰). Spatial downsampling 615 is performed to form a downsampled reprojected input video 620a (ending with the temporally coarsest input frames x^{K}). The downsampled reprojected input video 620a may be progressively downsampled to match the generative machine-learning model's 625 native height. For example, each level of reprojected input video 620 may be associated with a 2× downsampling. Although four levels are illustrated, any number of levels (k) may be used, such as from two to five levels or more than five levels. In some embodiments, the input video at temporal scale k (x^{k}) has a corresponding mask at temporal scale k (m^{k}).

Two different sliding spatial windows 621, 622 are used to provide portions of the base reprojected input video 620a to the generative machine-learning model 625. The sliding spatial windows 621, 622 may be associated with varying dimensions depending on the type of generative machine-learning model 625 that is used to generate the base video 630a. The sliding spatial windows 621, 622 advantageously enable the process 600 to be used with input videos 605 of varying panorama widths.

The generative machine-learning model 625 generates the base video 630a by performing spatial outpainting to generate synthesized pixels for the missing regions. The model predictions in the sliding spatial windows 631, 632 are averaged and a new sample is drawn from the average.

In embodiments where the generative machine-learning model 625 is a diffusion model, the projected panoramic canvas is cropped to each input window and missing regions outside the image frames are outpainted. The Gaussian distribution over pixel values (represented by μ and Σ) may be averaged, and a new sample may be drawn using diffusion methods, such as a Denoising Diffusion Probabilistic Model (DDPM).

In embodiments where the generative machine-learning model 625 is a token-based model, spatial aggregation may be performed by averaging the predicted probability distributions over the tokens before sampling.

The generative machine-learning model 625 progressively restores the temporal dimensions of the input video 605 by progressively completing panoramic videos at upsampled temporal resolutions. For each level k∈[K−1,0], the generative machine-learning model 625 combines a reprojected input video 620 (x^{k}) with a completed courser-level panoramic video (y^{k+1}) to produce a completed low resolution panoramic video 630 (y^{k}).

The generative machine-learning model 625 obtains consistent temporal details by performing temporal upsampling, merging with the reprojected input video 620, and resynthesizing pixels outside of the input regions to output low resolution panoramic videos 630. In some embodiments, temporal upsampling includes temporally upsampling a panoramic video y^{k+1} to create a

$${\hat{y}}_{up}^{k}$$

that is frame-rate matched and composite x^{k} over

$${\hat{y}}_{up}^{k}$$

to form a merged

$${\hat{y}}_{merge}^{k} .$$

In some embodiments, x^{k} is aligned to

$${\hat{y}}_{up}^{k}$$

prior to compositing using a grid-warp-based optical flow and color histogram matching.

Turning to FIG. 7, an example process 700 performed by a diffusion model is illustrated where the diffusion model performs upsampling and outpainting to generate a panoramic video, according to some embodiments described herein. The panoramic video from the previous level (y^{k+1}) 705 is temporally upsampled

$$( {\hat{y}}_{up}^{k} )$$

and merged with a current level reprojected input video (x^{k}) 715 to form a partially-completed input

$$( {\hat{y}}_{merge}^{k} ) .$$

The partially-completed input

$$( {\hat{y}}_{merge}^{k} )$$

matches the input video with the original mask (m^{k}) but lacks temporal details outside of the mask. As a result, outpainting 720 is used for context.

The diffusion model outpaints 720 (i.e., performs resynthesis of) content outside the original mask (m^{k}) to output the completed panoramic video (y^{k}) 725. In some embodiments, outpainting 720 is controlled by a mask conditioning signal. A full-frame mask is applied to the odd-numbered frames of the partially-completed input

$$( {\hat{y}}_{merge}^{k} )$$

and the original mask (m^{k}) is applied to the even-numbered frames.

During this process, the diffusion sampling is constrained to maintain the temporally-upsampled, synthesized pixels at the odd-numbered frames, while the synthesized pixels are resynthesized at the even-numbered frames. For videos with fast motion (e.g., a skier, a kayaker, a skateboarder, etc. or any scene where the subject motion meets a threshold rate of change between consecutive frames of the video), the temporally-upsampled pixels at odd-numbered frames may also need to be resynthesized. In that case, the full-frame masks are maintained at odd frames for a predetermined amount of the sampling schedule (e.g., ⅛), then the original mask (m^{k}) for the entire window is used so that the diffusion model synthesizes new temporal details for the missing regions outside of the original mask.

During outpainting 720, in the time dimension the diffusion model 734 is applied in a sliding-window fashion with half-window overlap (e.g., 40 frames) between two windows 730, 732. In the spatial dimension, multiple overlapping predictions are computed in parallel by the diffusion model 734, then aggregated 736 and the completed panoramic video (y^{k}) 725 is drawn from the average.

In some embodiments, the diffusion model 734 is fine tuned by randomly cropping videos to be 128×128 pixels and augmenting a set of synthetic and real panning video masks. In some embodiments, the diffusion model 734 is optimized for a diffusion denoising objecting with a squared error loss using dynamic masks (i.e., masks that change location in subsequent frames to simulate an input panning video).

In comparison to the diffusion model performing outpainting, the token-based model outpaints the pixels outside the mask (m^{k}) by masking and regenerating the corresponding tokens:

$${\hat{z}}_{m erge}^{k} = enc ( {\hat{y}}_{merge}^{k} ) \qquad Eq . 1$$

$${z}^{k} = x f ( {\hat{z}}_{merge}^{k} ⊙ {m}_{z}^{k} ) \qquad Eq . 2$$

where

$${\hat{z}}_{merge}^{k}$$

is the set of tokens encoded from

$${\hat{y}}_{merge}^{k} , {m}_{z}^{k}$$

is the token-level mask, z^{k} is the set of resynthesized tokens, enc is the token encoder, and xf is the token transformer network. The full sequence y^{k}=dec(z^{k}) is constructed using sliding temporal windows with an overlap of half the window length (e.g., five frames).

In some embodiments, the token-based model is fine tuned to reduce fidelity loss with the encoder/decoder architecture to better align the synthesized pixels with the input video and preserve details of the input in the outpainted regions. The decoder may be finetuned on patches of valid pixels prior to synthesizing the final result.

Turning to FIG. 8, an example comparison 800 is illustrated of how probabilities during outpainting using a token-based model compare to a diffusion model, according to some embodiments described herein. A reprojected input video 801 includes a missing region 802. The generative machine-learning model generates a sample 803 from two predicted probability distributions associated with two overlapping windows: a left window 804 and a right window 805. A token-based model outputs discrete token probabilities 806, 807 based on the left window 804 and right window 805, respectively, that are aggregated 808. A diffusion model outputs pixel probabilities 809, 810 based on a Gaussian distribution over pixel values (represented by μ and Σ) that are aggregated 811.

Once the final upsampled panoramic video 630d is generated, a spatial super resolution 635 is applied to the upsampled panoramic video 630d. The result is merged with the output from reprojecting the input panning video 605, to obtain the full resolution panoramic video 645.

FIG. 6B illustrates example numbers of frames at each stage where the generative machine-learning model is a token-based model 656 that accepts 11 frames 655. An input video 651 includes 35 frames. For the coarsest temporal scale, the reprojected input video is completed at 11 frames 655. The 2× upsampling of 11 frames is 22 frames 654, the 2× upsampling of 22 frames is 44 frames 653, and 44 frame version is resampled back to 35 frames 652.

FIG. 6C illustrates an example process 660 of converting an input video 661 to a panoramic video. The input video is of a person kayaking. The dashed square 662 in the input video highlights a section of the input video 661 where unobserved movement occurs during capture of the panning video. For example, as one person's kayak moves from left to right and another person's kayak moves from right to left, the activities in the dashed square 662 are not visible to the camera.

One difficulty in generating a panoramic video is ensuring that movement, such as a person using a paddle is properly aligned. The reprojected input video 663 includes unknown regions 664 where portions of the reprojected input video 663 are to be filled in with synthesized pixels to create a panoramic video. The person's movement with the paddle in the reprojected input video 663 goes from pausing to paddling to pausing again. If the synthetic pixels generated by the generative machine-learning model 665 are incorrectly generated, instead of the person having smooth expected movement with the paddle, various problems (e.g., discontinuous, jerky, or unnatural movement with the paddle) may occur.

The generative machine-learning model 665 outputs a panoramic video 666 where the missing regions are replaced with synthetic pixels and the synthesized images are merged with the reprojected input video 663. For example, the original pixels in the unmasked areas in the reprojected input video 663 are merged with synthesized images.

FIG. 6D illustrates the process 670 of finalizing the panoramic video using a token-based model 679. In this example, a low-resolution panoramic video 671 includes 11 frames with temporal context that are upsampled with the reprojected input video 672, which includes 22 frames and temporal details to result in a 2× upsampled video 673 with 22 frames. The upsampled video is modified by performing spatial alignment 674 (e.g., using temporal upsampling and frame-rate matching), color alignment 675 (e.g., through color histogram matching), and compositing 676 (e.g., using grid-warp-based optical flow or other types of image interpolation and/or blending), for example by using the process described in FIG. 6A, to result in a merged video 677 with 22 frames. In this example, a token-based model is used for generating synthesized pixels. In some embodiments where a different type of generative machine-learning model is used, such as a diffusion model, color alignment may not be performed.

The token-based model 679 may receive as input the merged video 677 with a mask 678 where the white portions represent the input and the black portions represent resynthesized pixels. The token-based model 679 may generate a mask of the pixels for the missing regions, resynthesize the pixels for the missing regions of the panoramic canvas, and merge the mask with the resynthesized pixels. The token-based model 679 outputs a high-resolution panoramic video 680 (i.e., with a threshold number of pixels) with 22 frames.

Once the panoramic video is finalized, the panoramic video may be provided to the user that captured the input panning video. In some embodiments, the panoramic video is displayed with an option to select a panoramic image from the panoramic video. For example, the panoramic video may be displayed as a series of panoramic images and a user interface may include an option for isolating one or more of the panoramic images.

### Example Method

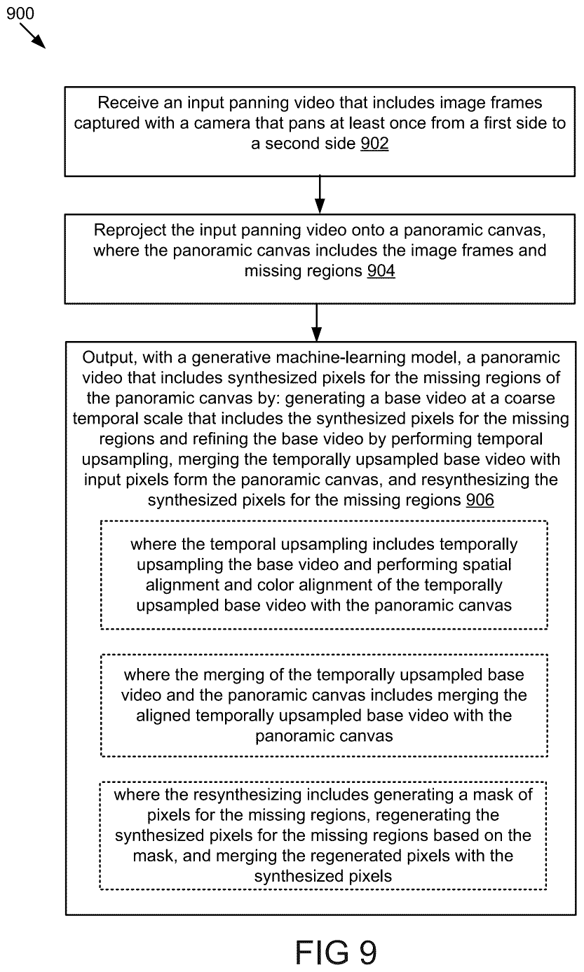

FIG. 9 illustrates a flowchart of an example method 900 to generate a panoramic video. The method 900 may be performed by the computing device 200 in FIG. 2. In some embodiments, the method 900 is performed by the user device 115, the media server 101, or in part the user device 115 and in part the media server 101.

The method 900 of FIG. 9 may begin at block 902. At block 902, an input panning video is received that includes image frames captured with a camera that pans at least once from a first side to a second side. In some embodiments, a quality of the panoramic video improves as a function of a number of times the image frames captured with the camera include panning from the first side to the second side and panning from the second side to the first side. In some embodiments, the input panning video includes one or more moving objects. Block 902 may be followed by block 904.

At block 904, the input panning video is reprojected onto a panoramic canvas, where the panoramic canvas includes the image frames and missing regions. Block 904 may be followed by block 906.

At block 906, a generative machine-learning model outputs a panoramic video that includes synthesized pixels for the missing regions of the panoramic canvas by: generating a base video at a coarse temporal scale that includes the pixels for the missing regions; and refining the base video by performing temporal upsampling, merging the temporally upsampled base video with the panoramic canvas, and resynthesizing the synthesized pixels for the missing regions.

The temporal upsampling may include temporally upsampling the base video and performing spatial alignment and color alignment of the temporally upsampled base video with the panoramic canvas to obtain an aligned temporally upsampled vase video. Merging the temporally upsampled base video with the panoramic canvas may include merging the aligned temporally upsampled base video with the panoramic canvas. The resynthesizing may include generating a mask of pixels for the missing regions, regenerating the synthesized pixels for the missing regions based on the mask, and merging the regenerated pixels with the synthesized pixels.

In some embodiments, responsive to outputting the panoramic video, a super-resolution pass is applied to the panoramic video to increase resolution of the panoramic video. In some embodiments, a panoramic image is selected from the panoramic video.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMS, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
receiving an input panning video that includes image frames captured with a camera that pans at least once from a first side to a second side;
reprojecting the input panning video onto a panoramic canvas, wherein the panoramic canvas includes the image frames and missing regions; and
outputting, with a generative machine-learning model, a panoramic video that includes synthesized pixels for the missing regions of the panoramic canvas, wherein the generative machine-learning model outputs the panoramic video by:
generating a base video at a coarse temporal scale that includes the synthesized pixels for the missing regions; and
refining the base video by performing temporal upsampling, merging the temporally upsampled base video with input pixels from the panoramic canvas, and resynthesizing the synthesized pixels for the missing regions.

2. The computer-implemented method of claim 1, wherein the temporal upsampling includes:
temporally upsampling the base video; and
performing spatial alignment and color alignment of the temporally upsampled base video with the panoramic canvas to obtain an aligned temporally upsampled vase video.

3. The computer-implemented method of claim 2, wherein the merging the temporally upsampled base video and the panoramic canvas includes merging the aligned temporally upsampled base video with the panoramic canvas.

4. The computer-implemented method of claim 3, wherein the resynthesizing includes generating a mask of pixels for the missing regions, regenerating the synthesized pixels for the missing regions based on the mask, and merging the regenerated pixels with the synthesized pixels.

5. The computer-implemented method of claim 1, wherein a quality of the panoramic video improves as a function of a number of times the image frames captured with the camera include panning from the first side to the second side and panning from the second side to the first side.

6. The computer-implemented method of claim 1, wherein the input panning video includes one or more moving objects.

7. The computer-implemented method of claim 1, further comprising responsive to outputting the panoramic video, applying a super-resolution pass to the panoramic video to increase resolution of the panoramic video.

8. The computer-implemented method of claim 1, further comprising selecting a panoramic image from the panoramic video.

9. A non-transitory computer-readable medium with instructions stored thereon that, when executed by one or more computers, cause the one or more computers to perform operations, the operations comprising:
receiving an input panning video that includes image frames captured with a camera that pans at least once from a first side to a second side;
reprojecting the input panning video onto a panoramic canvas, wherein the panoramic canvas includes the image frames and missing regions; and
outputting, with a generative machine-learning model, a panoramic video that includes synthesized pixels for the missing regions of the panoramic canvas, wherein the generative machine-learning model outputs the panoramic video by:
generating a base video at a coarse temporal scale that includes the synthesized pixels for the missing regions; and
refining the base video by performing temporal upsampling, merging the temporally upsampled base video with input pixels from the panoramic canvas, and resynthesizing the synthesized pixels for the missing regions.

10. The non-transitory computer-readable medium of claim 9, wherein the temporal upsampling includes:
temporally upsampling the base video; and
performing spatial alignment and color alignment of the temporally upsampled base video with the panoramic canvas to obtain an aligned temporally upsampled vase video.

11. The non-transitory computer-readable medium of claim 10, wherein the merging the temporally upsampled base video and the panoramic canvas includes merging the aligned temporally upsampled base video with the panoramic canvas.

12. The non-transitory computer-readable medium of claim 11, wherein the resynthesizing includes generating a mask of pixels for the missing regions, regenerating the synthesized pixels for the missing regions based on the mask, and merging the regenerated pixels with the synthesized pixels.

13. The non-transitory computer-readable medium of claim 9, wherein the input panning video includes one or more moving objects.

14. The non-transitory computer-readable medium of claim 9, wherein the operations further comprise responsive to outputting the panoramic video, applying a super-resolution pass to the panoramic video to increase resolution of the panoramic video.

15. The non-transitory computer-readable medium of claim 9, wherein the operations further comprise selecting a panoramic image from the panoramic video.

16. A system comprising:
a processor; and
a memory coupled to the processor, with instructions stored thereon that, when executed by the processor, cause the processor to perform operations comprising:
receiving an input panning video that includes image frames captured with a camera that pans at least once from a first side to a second side;
reprojecting the input panning video onto a panoramic canvas, wherein the panoramic canvas includes the image frames and missing regions; and
outputting, with a generative machine-learning model, a panoramic video that includes synthesized pixels for the missing regions of the panoramic canvas, wherein the generative machine-learning model outputs the panoramic video by:
generating a base video at a coarse temporal scale that includes the synthesized pixels for the missing regions; and
refining the base video by performing temporal upsampling, merging the temporally upsampled base video with input pixels from the panoramic canvas, and resynthesizing the synthesized pixels for the missing regions.

17. The system of claim 16, wherein the temporal upsampling includes:
temporally upsampling the base video; and
performing spatial alignment and color alignment of the temporally upsampled base video with the panoramic canvas to obtain an aligned temporally upsampled vase video.

18. The system of claim 17, wherein the merging the temporally upsampled base video and the panoramic canvas includes merging the aligned temporally upsampled base video with the panoramic canvas.

19. The system of claim 18, wherein the resynthesizing includes generating a mask of pixels for the missing regions, regenerating the synthesized pixels for the missing regions based on the mask, and merging the regenerated pixels with the synthesized pixels.

20. The system of claim 16, wherein the input panning video includes one or more moving objects.
